(19) United States
(12) Patent Application Publication
(10) Pub. No.: US 2003/0140062 A1
(43) Pub. Date: Jul. 24, 2003

(54) Card management system and server

(75) Inventor: Takashi Ueno, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: R & B 21, Tokyo (JP)

(21) Appl. No.: 10/195,069

(22) Filed: Jul. 15, 2002

(30) Foreign Application Priority Data
Jan. 24, 2002 (JP) 2002-015341

(51) Int. Cl. G06F 7/00

(52) U.S. Cl. 707/104.1

(57) ABSTRACT

A card management system includes a server; and first and second terminals connected to the server via a network. When a customer sends a card (e.g., a redemption card) to a card maker, the customer transmits card submission data to the server by use of the first terminal. The card maker transmits card acceptance data and card dispatch data to the server by use of the second terminal. Further, the customer transmits dispatch status data to the server by use of the first terminal. Whenever the server receives the above-described data, the server stores the data in a database, and discloses the data on the network in the form of a list.

### BACKGROUND OF THE INVENTION

1. Field of the Invention

The present invention relates to a card management system, and more particularly to a card management system which discloses on a network after-sales services which a card maker has provided for cards purchased by card collectors, to thereby promote quick and proper after-sales services provided by the card maker.

2. Description of the Related Art

Cards called trading cards (hereinafter simply referred to as cards), each including a substrate formed of plastic or a like material and carrying a photograph, name, etc. of, for example, a famous athlete (hereinafter also called a “player”) printed on the substrate, are sold in the United State of America and other countries; and a large number of card collectors who purchase and collect such cards reside in Japan.

In general, such cards are sold in the form of a set including a plurality of cards (hereinafter referred to as a “card pack”). Most cards are such that a photograph, name, etc. of, for example, a famous athlete are printed on a substrate formed of plastic or a like material, as described above. However, some cards are rare cards; e.g., a card which carries a photograph of a player and an actual autograph of the player, and a card to which a portion of a uniform the player actually wore is bonded (hereinafter referred to as “rare cards”).

For card collectors, obtaining rare cards is a major reason for buying cards. Card makers which produce and sell cards promote their sales while capitalizing on rareness of cards.

When a card maker sells cards which carry a photograph of a player, the card maker enters into a contract with the player before the sales, and provision of autographs and a uniform is contained in the contract as an agreed matter. However, in some cases, rare cards cannot be produced as scheduled, due to the schedule of the player, unavailability of the uniform, or other factors.

Further, since card makers expect that difficulty in obtaining rare cards arouses the collectors' desire to purchase cards, recently many card makers have employed a sales method such that instead of a rare card itself, a card pack contains a coupon which can be exchanged for a specific rare card (hereinafter referred to as a “redemption card”); and when a card collector sends the redemption card to the corresponding card maker, the card maker sends the rare card to the collector.

However, this arrangement has involved problems, such that a collector having sent a redemption card to a card maker must wait for a very long period before receiving a rare card, that the collector receives a card different from the card described on a redemption card as a rare card to be provided, that a redemption card itself is sent back, or that the card maker fails to provide any response.

Even in the case in which a rare card itself is included in a card pack, the rare card may be damaged; i.e., the card is bent, or the printed portion of the card is partially lifted or peeled off (hereinafter referred to as a “damaged card”). Even in such a case, some card makers do not comply with collectors' demands for returning, exchanging, or repairing the damaged card. Further, since rare cards are traded at high price among maniacs and others, fake cards may be circulated.

### SUMMARY OF THE INVENTION

In view of the forgoing, an object of the present invention is to provide a card management system and a server, which discloses, on a network, information which is provided from both card collectors and card makers in relation to, for example, a manner in which a maker handles a redemption card, conditions of a damaged card and a manner in which a maker handles the damaged card, and images of fake cards, to thereby stimulate card makers to provide quick and proper after-sales services, and enable the card makers to obtain trust of card collectors and to promote sales.

In order to achieve the above object, a card management system according to a first aspect of the present invention comprises a server; and first and second terminals connected to the server via a network. The first terminal comprises means for transmitting to the server first data including information for specifying a card and information representing a condition of the card. The server comprises means for storing the first data; and means for disclosing the first data on the network. The second terminal comprises means for transmitting to the server second data including information representing the manner in which a maker of the card has handled the card. The first terminal further comprises means for transmitting to the server third data including information representing a manner in which the maker of the card has handled the card. The server further comprises means for storing the second and third data; and means for disclosing the second and third data on the network.

The server may include means for assigning a unique number or symbol to the first data; means for storing the assigned number or symbol together with the first data; and means for disclosing on the network the assigned number or symbol together with the first data. The card may be a redemption card or a damaged card.

Here, the term “card” refers to a card which is purchased for collection and other purposes, such as a so-called trading card in which a photograph, name, etc., of a famous athlete is printed on a substrate formed of, for example, plastic.

The redemption card refers to a coupon to be exchanged for a rare card, such as a card carrying a real autograph of a player. When a customer sends a redemption card to the card maker, a predetermined card is sent back to the customer. The damaged card refers to a defective card.

Another card management system according to the first aspect of the present invention comprises a server; and first and second terminals connected to the server via a network. The first terminal comprises means for transmitting to the server first data including information for specifying a card which is suspected to be fake and image information of the card. The second terminal comprises means for transmitting to the server second data including an opinion on the card of the maker of the card. The server comprises means for storing the first and second data; and means for disclosing the first and second data on the network.

The server may include means for assigning a unique number or symbol to the first data; means for storing the assigned number or symbol together with the first data; and means for disclosing on the network the assigned number or symbol together with the first data.

A server according to a second aspect of the present invention is connected to first and second terminals via a network, and comprises means for storing first data transmitted from the first terminal and including information for specifying a card and information representing a condition of the card, second data transmitted from the second terminal and including information representing a manner in which a maker of the card has handled the card, and third data transmitted from the first terminal and including information representing a manner in which the maker of the card has handled the card; and means for disclosing the first, second, and third data on the network.

The server may include means for assigning a unique number or symbol to the first data; means for storing the assigned number or symbol together with the first data; and means for disclosing on the network the assigned number or symbol together with the first data. The card may be a redemption card or a damaged card.

Another server according to the second aspect of the present invention is connected to first and second terminals via a network, and comprises means for storing first data transmitted from the first terminal and including information for specifying a card which is suspected to be fake and an image information of the card, and second data transmitted from the second terminal and including an opinion on the card of the maker of the card; and means for disclosing the first and second data on the network.

The server may include means for assigning a unique number or symbol to the first data; means for storing the assigned number or symbol together with the first data; and means for disclosing on the network the assigned number or symbol together with the first data.

According to the present invention, since the manner in which a card maker handles cards such as redemption cards, damaged cards, and fake cards is disclosed, when the card maker handles those cards unfaithfully, the unfaithful treatment becomes widely known among many consumers, and may hinder sales activity. Therefore, the card maker can be expected to provide quick and proper handling of cards; and consumers can purchase cards without anxiety. Moreover, if the card maker always provide faithful handling, the card maker can gain consumers' trust, so that the card maker and their agencies can promote sales.

### BRIEF DESCRIPTION OF THE DRAWINGS

FIG. 1 is a schematic block diagram of a card management system according to an embodiment of the present invention;

FIG. 2 is a diagram showing example customer data;

FIG. 3 is a diagram showing example first card submission data;

FIG. 4 is a diagram showing example second card submission data;

FIG. 5 is a diagram showing example card genuine/fake data;

FIG. 6 is a diagram showing example card maker data;

FIG. 7 is a diagram showing example card acceptance data;

FIG. 8 is a diagram showing example card dispatch data;

FIG. 9 is a diagram showing example card-maker comment data;

FIG. 10 is a diagram showing example dispatch status data;

FIG. 11 is a diagram showing example correction status data;

FIG. 12 is a flowchart showing operation of the card management system for a redemption card;

FIG. 13 is a diagram showing an example screen for inputting a registration type;

FIG. 14 is a diagram showing an example screen for inputting customer data;

FIG. 15 is a diagram showing an example screen for inputting first card submission data;

FIG. 16 is a diagram showing an example acceptance completion screen;

FIG. 17 is an example list of data to be disclosed;

FIG. 18 is a flowchart showing operation of the card management system for a damaged card; and

FIG. 19 is a flowchart showing operation of the card management system for a card which may be fake.

### DESCRIPTION OF THE PREFERRED EMBODIMENT

An embodiment of the present invention will now be described in detail with reference to the drawings.

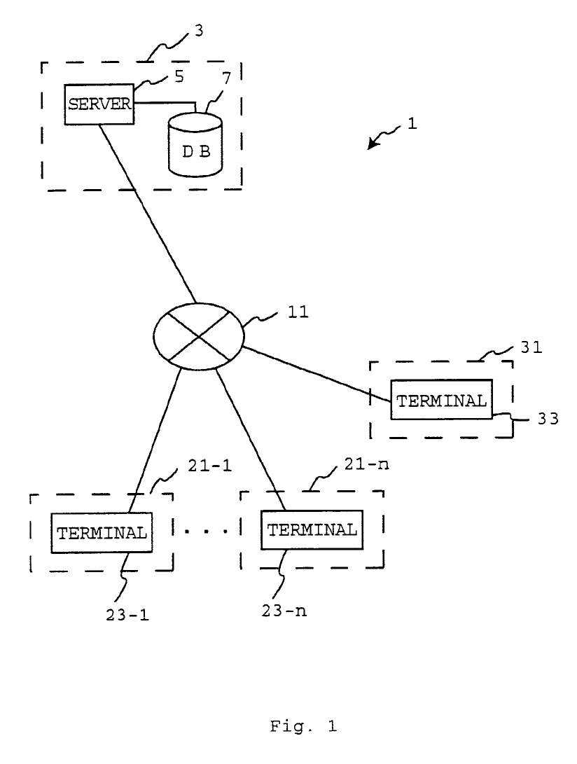

As shown in FIG. 1, a card management system 1 according to the embodiment of the present invention includes a server 5, and terminals 23, 33, etc. connected to the server 5 via a network 11.

The server 5 has a database 7 and is provided at a service provider 3 together with the database 7. The database 7 stores customer data 100, first card submission data 120, second card submission data 140, card genuine/fake data 160, card maker data 200, card acceptance data 210, card dispatch data, 220, card-maker comment data 230, dispatch status data 240, correction status data 250, and other data. The database 7 may be provided for each of these data sets. The details of these data sets will be described later.

The terminal 23 is provided at the place of a customer 21 who purchase cards, may desire after-sales service of a card maker, and uses the card management system 1. A plurality of customers 21 may be present. The terminal 33 is provided at the place of a card maker 31 who produces and sells cards. A plurality of card makers 31 may be present.

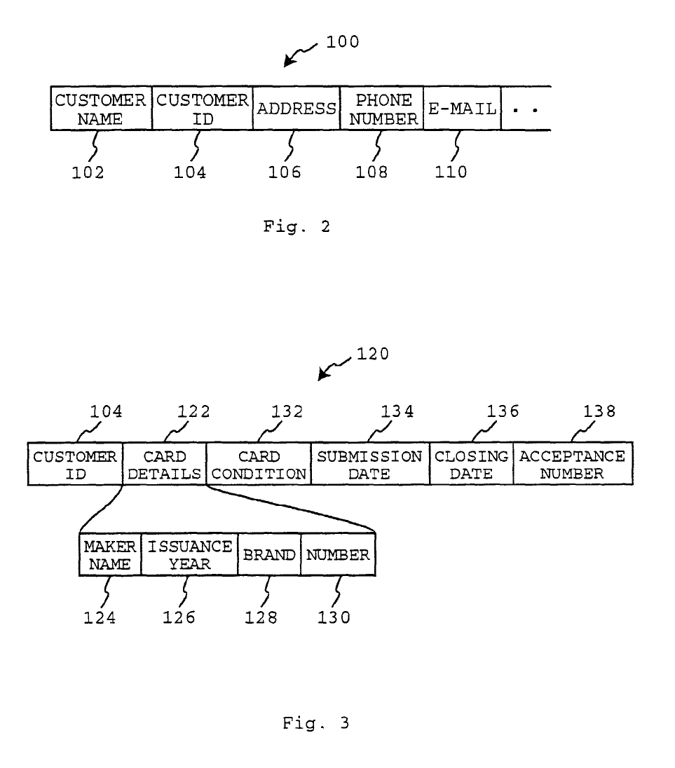

As shown in FIG. 2, the customer data 100 contain customer name data 102, customer ID data 104, address data 106, phone number data 108, E-mail data 110, etc.

The customer name data 102 represent the name of the customer 21 who uses the card management system 1. The customer ID data 104 represent a number or symbol which is assigned to the customer 21 for the purpose of identification. However, a phone number may be used to identify the customer 21. The address data 106 represent the address of the customer 21. The phone number data 108 represent the phone number of the customer 21. The E-mail data 110 represent a mail account owned by the customer 21. The customer data 100 are transmitted from the terminal 23 to the server 5 and are stored in the database 7.

As shown in FIG. 3, the first card submission data 120 contain the customer ID data 104, card details data 122, card condition data 132, submission date data 134, closing date data 136, acceptance number data 138, etc.

The card details data 122 are used to specify a card which the customer 21 purchased and for which the customer 21 desires the card maker 31 to provide after-sales services. The card details data 122 include maker name data 124, issuance year data 126, brand data 128, and number data 130. The maker name data 124 represent the name of a card maker (e.g., the card maker 31) which produced the above-described card. The issuance year data 126 represent a year in which the card was issued. The brand data 128 represent a unique name representing the type of the card. The number data 130 represent a serial number assigned to the card.

The card condition data 132 represent a classification of the card; e.g., a redemption card, a damaged card, or a fake card. In the present example, the card condition data 132 represent that the card is a redemption card. The submission date data 134 represent a date on which the customer 21 submitted the card to the card maker 31.

The closing date data 136 represent a closing date for submission of the redemption card and may include data representing whether an application postmarked on the closing date is acceptable or an application must arrive at the card maker on or before the closing date. The acceptance number data 138 represent a symbol or number which the server 5 allocates, upon receipt of the first card submission data 120, for the purpose of identification. The first card submission data 120 are transmitted from the terminal 23 to the server 5 and are stored in the database 7 after addition of the acceptance number data 138 by the server 5.

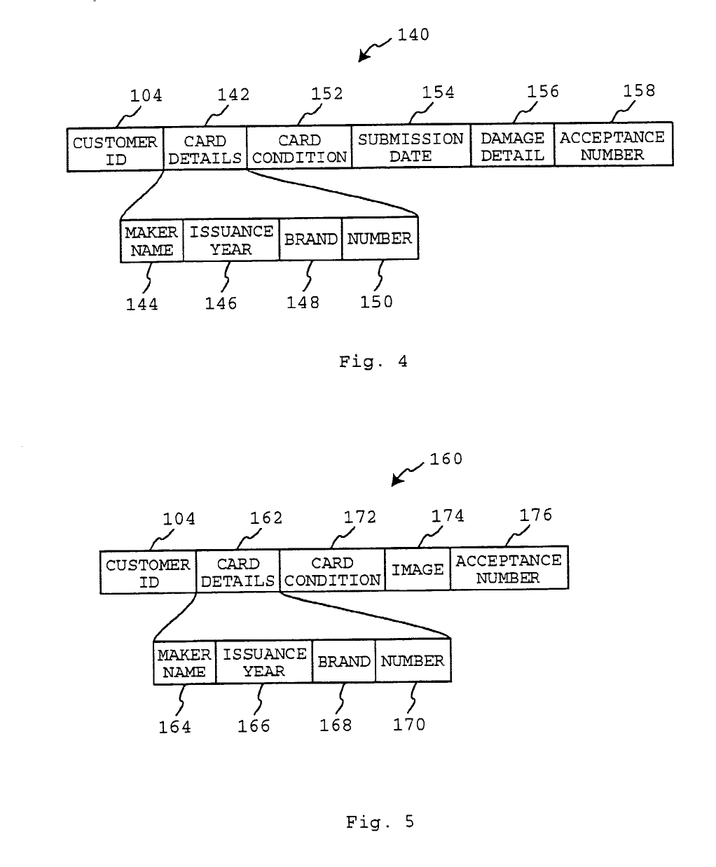

As shown in FIG. 4, the second card submission data 140 contain the customer ID data 104, card details data 142, card condition data 152, submission date data 154, damage details data 156, acceptance number data 158, etc.

The card details data 142 are used to specify a card which the customer 21 purchased and for which the customer 21 desires the card maker 31 to provide after-sales services. The card details data 142 include maker name data 144, issuance year data 146, brand data 148, and number data 150. The maker name data 144 represent the name of a card maker (e.g., the card maker 31) which produced the above-described card. The issuance year data 146 represent a year in which the card was issued. The brand data 148 represent a unique name representing the type of the card. The number data 150 represent a serial number assigned to the card.

The card condition data 152 represent a classification of the card; e.g., a redemption card, a damaged card, or a fake card. In the present example, the card condition data 152 represent that the card is a damaged card. The submission date data 154 represent a date on which the customer 21 submitted the card to the card maker 31.

The damage details data 156 represent conditions of a damaged portion of the damaged card; e.g., lifting or exfoliation of a printed portion, or bending of the card. The acceptance number data 158 represent a symbol or number which the server 5 allocates, upon receipt of the second card submission data 140, for the purpose of identification. The second card submission data 140 are transmitted from the terminal 23 to the server 5 and are stored in the database 7 after addition of the acceptance number data 158 by the server 5.

As shown in FIG. 5, the card genuine/fake data 160 contain the customer ID data 104, card details data 162, card condition data 172, image data 174, acceptance number data 176, etc.

The card details data 162 are used to specify a card which the customer 21 purchased and for which the customer 21 desires the card maker 31 to provide after-sales services. The card details data 162 include maker name data 164, issuance year data 166, brand data 168, and number data 170. The maker name data 164 represent the name of a card maker (e.g., the card maker 31) which is displayed to have produced the above-described card. The issuance year data 166 represent an issuance year displayed on the card. The brand data 168 represent a unique name representing the type of the card. The number data 170 represent a serial number assigned to the card.

The card condition data 172 represent a classification of the card; e.g., a redemption card, a damaged card, or a fake card. In the present example, the card condition data 172 represent that the card is a fake card. The image data 174 are image data of a card which is suspected to be a fake card, which data are obtained by use of, for example, a scanner or a digital camera. However, the image data 174 may represent an address at which the image data are stored, a file name, or the like.

The acceptance number data 176 represent a symbol or number which the sever 5 allocates, upon receipt of the card genuine/fake data 160, for the purpose of identification. The card genuine/fake data 160 are transmitted from the terminal 23 to the server 5 and are stored in the database 7 after addition of the acceptance number data 176 by the server 5.

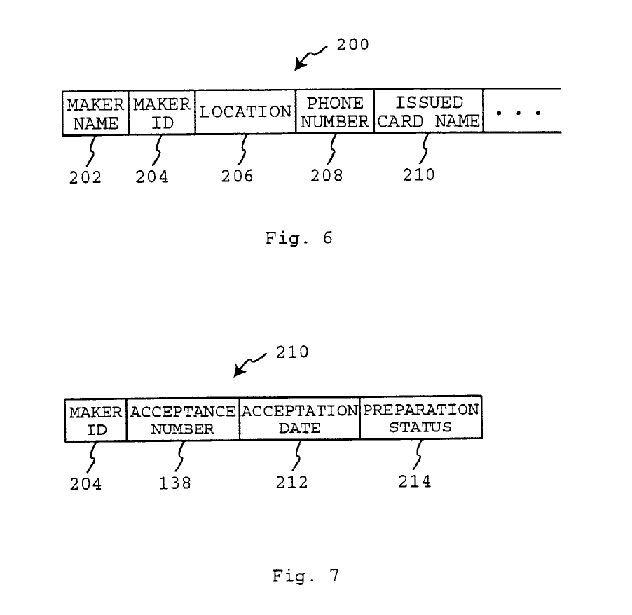

As shown in FIG. 6, the card maker data 200 contain maker name data 202, maker ID data 204, location data 206, phone number data 208, issued card name data 210, etc.

The maker name data 202 represent the name of a maker which produced a card for which the customer 21 desires after-sales services. The maker ID data 204 represent a symbol or number which is assigned to the maker for the purpose of identification. The maker ID may be a phone number.

The location data 206 represent the location of the card maker. The phone number data 208 represent the phone number of the card maker. The issued card name data 210 represent a brand name or the like of a card that the card maker issues. The card maker data 200 are transmitted from the terminal 33 to the server 5 and are stored in the database 7.

As shown in FIG. 7, the card acceptance data 210 contain the maker ID data 204, the acceptance number data 138, acceptation date data 212, preparation status data 214, etc. The acceptance number data 138 represent an acceptance number which has been assigned to the first card submission data 120 which the card maker 31 will handle. This establishes correspondence between the first card submission data 120 and the card acceptance data 210. When the card is a damaged card, in place of the acceptance number data 138, the acceptance number data 158 are added in order to establish correspondence between the second card submission data 140 and the card acceptance data 210.

The acceptation date data 212 represent a date on which a redemption card sent from the customer 21 has been accepted. The preparation status data 214 represent whether a rare card to be sent in exchange for the redemption card is present at the card maker 31. When the card is a damaged card, the preparation status data 214 represent whether a card to replace the damage card is present at the card maker 31. The card acceptance data 210 are transmitted from the terminal 33 to the server 5 and are stored in the database 7.

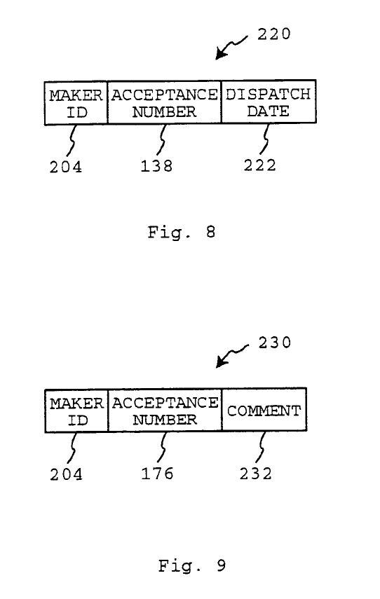

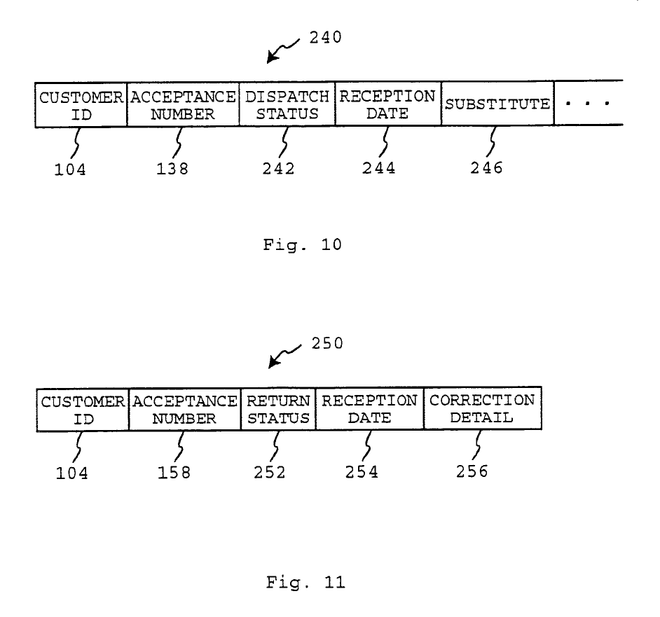

As shown in FIG. 8, the card dispatch data 220 contain the maker ID data 204, the acceptance number data 138, dispatch date data 222, etc. The acceptance number data 138 represent an acceptance number which has been assigned to the first card submission data 120 which the card maker 31 will handle. This establishes correspondence between the first card submission data 120 and the card dispatch data 220. When the card is a damaged card, in place of the acceptance number data 138, the acceptance number data 158 are added in order to establish correspondence between the second card submission data 140 and the card dispatch data 220.

When the card is a redemption card, the dispatch date data 222 represent a date on which the card maker 31 has sent to the client 21 a predetermined rare card or a substitute. When the card is a damaged card, the dispatch date data 222 represent a date on which the card maker 31 has sent the card to the client 21 after repair or the card maker 31 has sent a new card to the client 21 as an exchange. The card dispatch data 220 are transmitted from the terminal 33 to the server 5 and are stored in the database 7.

As shown in FIG. 9, the card-maker comment data 230 contain the maker ID data 204, the acceptance number data 176, comment data 232, etc. The acceptance number data 176 represent an acceptance number which has been assigned to the card genuine/fake data 160. This establishes correspondence between the card genuine/fake data 160 and the card-maker comment data 230. The comment data 232 represent opinions of the card maker 31 on a card which the card maker 31 has checked on the basis of the image data 174. The card-maker comment data 230 are transmitted from the terminal 33 to the server 5 and are stored in the database 7.

As shown in FIG. 10, the dispatch status data 240 contain the customer ID data 104, the acceptance number data 138, dispatch status data 242, reception date data 244, and substitute article data 246. The dispatch status data 242 represent whether a rare card or a substitute has been dispatched from the card maker 31.

The reception date data 244 represent a date on which the customer 21 has received the dispatched card or article. The alternative article data 246 represent an article which has been sent in place of a rare card which the card maker 31 had agreed to send in exchange for the redemption card sent from the customer 21. The dispatch status data 240 are transmitted from the terminal 23 to the server 5 and are stored in the database 7.

As shown in FIG. 11, the correction status data 250 contain customer the ID data 104, the acceptance number data 158, return status data 252, reception date data 254, and correction details data 256.

The return status data 252 represent whether a damaged card which the customer 21 had sent to the card maker 31 has been returned to the customer 21. The reception date data 254 represent a date on which the customer 21 has received the returned card. The correction details data 256 represent the details of a repair performed on the damaged card. The system of the present embodiment may be modified in such a manner that when an exchange or a substitute is sent back to the customer 21, the correction details data 25 represent the exchange or substitute. The correction status data 250 are transmitted from the terminal 23 to the server 5 and are stored in the database 7.

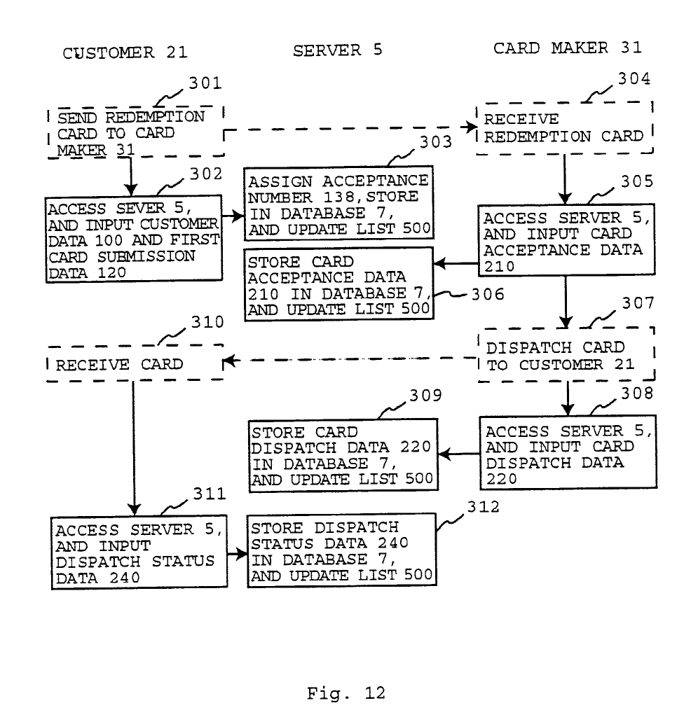

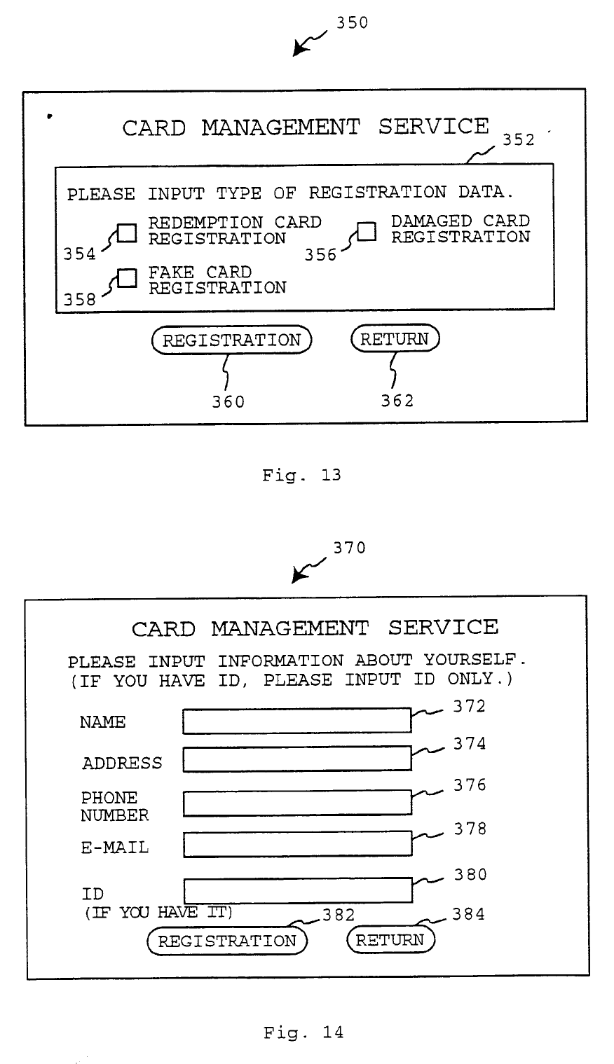

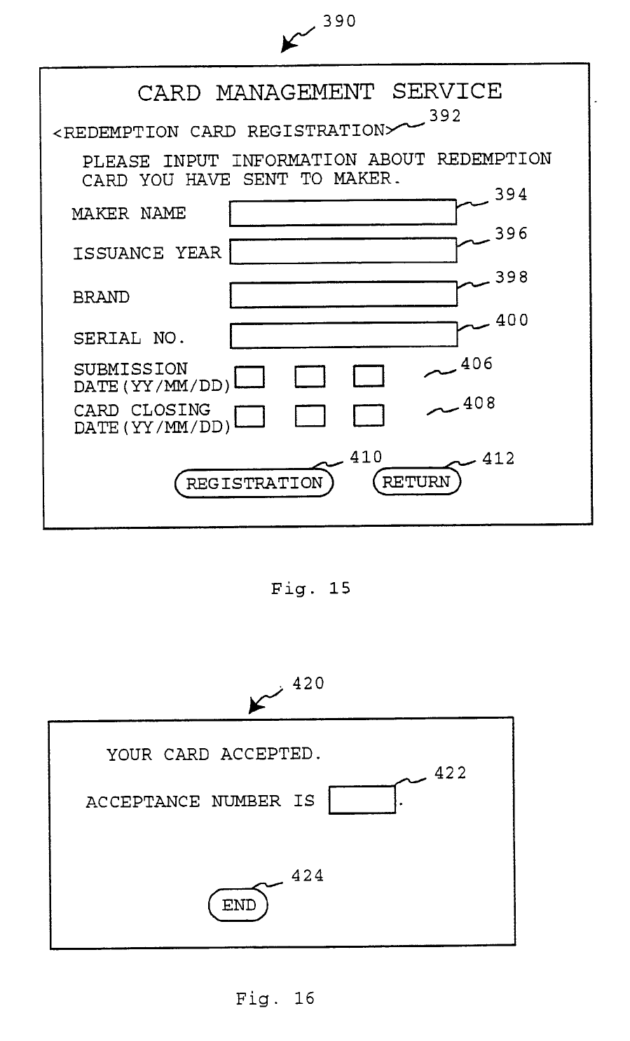

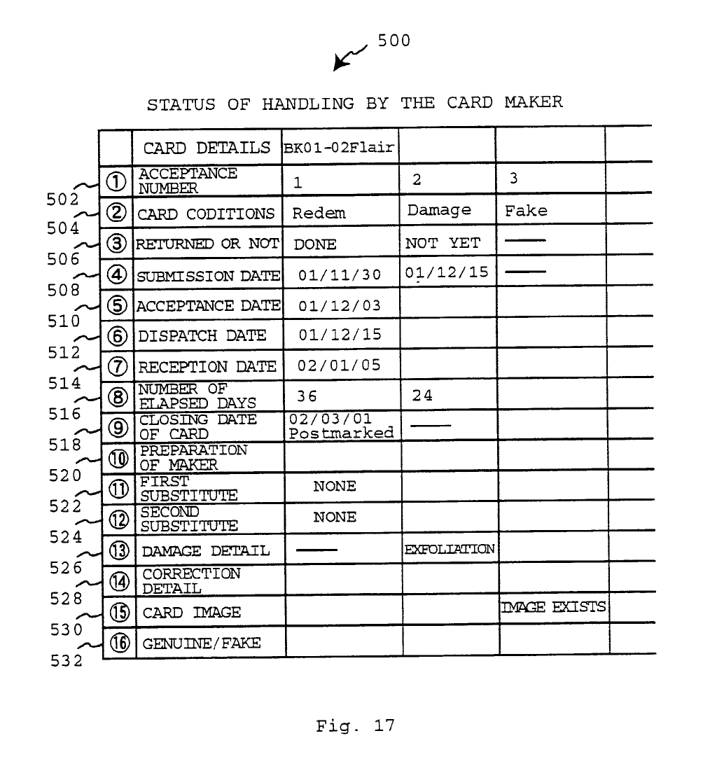

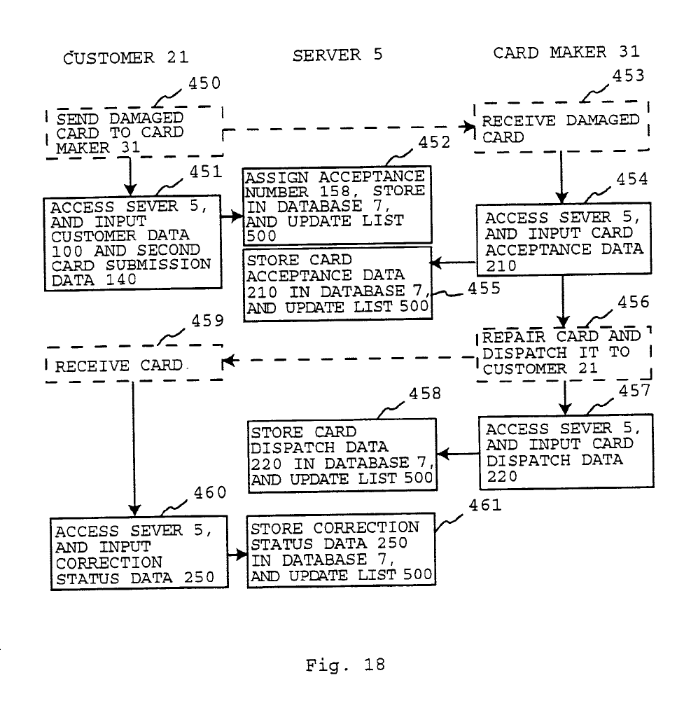

Next, operation of the card management system 1 according to the present embodiment will be described with reference to FIGS. 12 to 17. FIG. 12 is a flowchart showing operation of the card management system 1 for a redemption card; FIG. 13 is a diagram showing an example screen 350 for inputting a registration type; FIG. 14 is a diagram showing an example screen 370 for inputting customer data; FIG. 15 is a diagram showing an example screen 390 for inputting first card submission data; FIG. 16 is a diagram showing an example acceptance completion screen 420; and FIG. 17 is an example list 500 of data to be disclosed.

As shown in FIG. 12, when a redemption card is contained in a card pack purchased by the customer 21, the customer 21 mails the redemption card to the card maker 31 (step 301) and accesses the server 5 from the terminal 23 in order to input the customer data 100 and the first card submission data 120 (step 302).

Specifically, the customer 21 operates the terminal 23 to display the registration type input screen 350 shown in FIG. 13; checks a check box 354 corresponding to redemption card registration in this example; and then clicks a registration button 360.

The server 5 detects that the terminal 23 performs registration of a redemption card, and causes the terminal 23 to display the customer-data input screen 370 shown in FIG. 14. On the terminal 23, the customer 21 inputs predetermined data items in a name column 372, an address column 374, a phone number column 376, and an E-mail column 378; and then clicks a registration button 382. As a result, the data items are transmitted as the customer name data 102, the address data 106, the phone number data 108, and the E-mail data 110 of the customer data 100, respectively. When the access is not the first access by the customer 21, the customer 21 may input a customer ID in an ID column 380 to thereby omit input of data items into the remaining input columns.

Further, the server 5 causes the terminal 23 to display the first-card-submission-date input screen 390 shown in FIG. 15. On the terminal 23, the customer 21 inputs predetermined data items in a maker-name input column 394, an issuance-year input column 396, a brand input column 398, a serial-number input column 400, a submission-date input column 406, and a card-closing-date input column 408; and then clicks a registration button 410. As a result, the data items are transmitted as the maker name data 124, the issuance year data 126, the brand data 128, the number data 130, the submission date data 134, and the closing date data 136 of the first card submission data 120.

The server 5 adds to the first card submission data 120 the card condition data 132 indicating that the submitted card is a redemption card and the acceptance number data 138 indicating an acceptance number; stores them to the data base 7; and updates the list 500 (step 303). Specifically, the server 5 writes the contents of the first card submission data 120 into a corresponding column of the list 500; and opens the list 500 on the network.

At this time, the server 5 causes the terminal 23 to display the acceptance completion display screen 420 shown in FIG. 16, and the acceptance number represented by the acceptance number data 138 is displayed in a display column 422 in order to communicate the acceptance number to the customer 21. By operating the terminal 23, the customer 21 clicks an end button 424 to thereby complete the data registration.

Here, the list 500 will be described. As shown in FIG. 17, the list 500 includes display columns 502, 504, . . . , 532, etc. and is disclosed on the network. In the example of FIG. 17, “1,” “2,” and “3” are displayed in the display column 502 as acceptance numbers, which correspond to the above-described acceptance number data 138, 158, and 176, respectively.

Card conditions are displayed in the display column 504 and correspond to the above-described card condition data 132, 152, 172, respectively. In the example of FIG. 17, “Redem,” “Damage,” and “Fake” are displayed and represent a redemption card, a damaged card, and a possible fake card, respectively.

Data representing whether the card has been sent back are displayed in the display column 506. In the example of FIG. 17, “Done” and “Not Yet” are displayed. The data representing whether the card has been sent back correspond to the above-described dispatch status data 242 and return status data 252.

Submission dates are displayed in the display column 508. In the example of FIG. 17, “01/11/30,” etc. are displayed. The submission dates correspond to the above-described submission date data 134 and 154. Like the display column 508, acceptance dates, dispatch dates, and reception dates are displayed in the display columns 510, 512, and 514, respectively. The acceptance dates correspond to the above-described acceptance date data 212; the dispatch dates correspond to the above-described dispatch date data 222; and the receipt dates correspond to the above-described reception date data 244 and 254.

Elapsed days counts are displayed in the display column 516. The elapsed days counts each represent the number of days which have elapsed since the corresponding submission date displayed on the display column 508 and represented by the submission date data 134 or 154. The elapsed days counts are automatically calculated and displayed by the server 5. The server 5 may be programmed in such a manner that when the server 5 receives the reception date data 244 or 254, the server 5 stops counting of the corresponding elapsed days count.

The closing dates of the cards are displayed in the display column 518. In the example of FIG. 17, “02/03/01 Postmarked,” etc. are displayed. This is input when a redemption card is submitted, and means that an application postmarked on the closing data is acceptable. The closing dates correspond to the above-described closing date data 136.

Data representing preparation by the maker are displayed in the display column 520. The data representing preparation by the maker correspond to the above-described preparation status data 214. In the example of FIG. 17, “Non” is displayed in the display columns 522 and 524 for substitute articles. However, if any substitute articles are present, their details are displayed. These data correspond to the substitute article data 246. In the example of FIG. 17, two substitute articles can be displayed. However, when three or more substitute articles are present, the number of the corresponding display columns may be increased in order to display them.

Correction details are displayed in the display column 528. Correction details are input when a damaged card is submitted and correspond to the above-described correction details data 256. Data representing whether a card image is present are displayed in the display column 530. In the example of FIG. 17, “Image Exists” is displayed. The data representing whether a card image is present correspond to the image data 174. The server 5 may be configured in such a manner that when the portion of “Image Exists” in the display column 530 is clicked, the image of the corresponding card is displayed. Data representing genuine/fake are displayed in the display column 532 and correspond to the above-described comment data 232. Whenever the server 5 receives the above-described respective data from the terminal 23 or 33, the server 5 updates data in the corresponding column of the list 500.

Returning back to FIG. 12, in step 303, corresponding data are displayed in the display columns 502, 504, 508, and 518. The card maker 31 receives the redemption card sent from the customer 21 (step 304); and accesses the server 5 from the terminal 33 in order to input card acceptance data 210 (step 305). When the card maker 31 accesses the server 5 from the terminal 33 for the first time, the card maker may input the card maker data 200.

The server 5 receives the card acceptance data 210; stores the data into the database 7; and updates the corresponding data of the list 500 (step 306). At this time, the corresponding display items are displayed in the display columns 510 and 520 of the list 500.

Meanwhile, the card maker 31 dispatches to the customer 21 a rare card which is to be sent in exchange for the redemption card, or a substitute article equivalent thereto (step 307). Subsequently, the card maker 31 accesses the server 5 and inputs the card dispatch data 220 (step 308).

The server 5 receives the card dispatch data 220; stores the data into the database 7; and updates corresponding portions of the list 500 (step 309). At this time, data are displayed at the corresponding portion in the display column 512. Meanwhile, when the customer 21 receives the card dispatched from the card maker 31 (step 310), the customer 21 accesses the server 5 and inputs the dispatch status data 240 (step 311).

The server 5 receives the dispatch status data 240; stores the data into the database 7; and updates corresponding portions of the list 500 (step 312). At this time, data are displayed at the corresponding portions in the display columns 506 and 514. When substitute articles are present, data are displayed at the corresponding portions in the display columns 522 and 524 as well. Simultaneously, the counting of the elapsed days count displayed in the display column 516 is stopped, so that the number of days elapsed between the submission date and the reception date is displayed. When the card maker 31 does not dispatch any card to the customer 21, since the customer 21 naturally cannot receive any card, step 307 and subsequent steps are not performed. In such a case, items corresponding to the card dispatch data 220 and the dispatch status data 240 are not displayed on the list 500; and the counting of the elapsed days count displayed in the display column 516 is continued.

As described above, when the customer 21 requests the card maker 31 to process the redemption card, the card management system 1 displays the details of the progress on the list 500, and discloses the list 500 on the network 11. Thus, the card management system 1 widely discloses the processing performed by the card maker 31, to thereby motivate the card maker 31 to provide responsible after-sales services.

Further, the ratio of dispatched rare cards to submitted redemption cards, the ratio of erroneous dispatches, the ratio of alternative articles, etc. can be calculated from the respective data and the list 500 stored in the database 7. The customer 21 can refer the ratios when he or she purchases a new card. When the card maker 31 provides faithful after-sales services, the card maker 31 can let many customers know about the faithful services, and can gain customer's trust. Thus, the card maker 31 can promote sales.

Notably, the list 500 includes only data for display. For example, although the server 5 stores the customer data 100 associated with the acceptance number “1,” the server 5 does not disclose the customer data 100.

The server 5 generates data for the list 500 by making use of data transmitted from the terminals 23-1, . . . , 23-n, 33, etc. At this time, the server 5 generates such data, while preventing disclosure of the customer data 100 and other data.

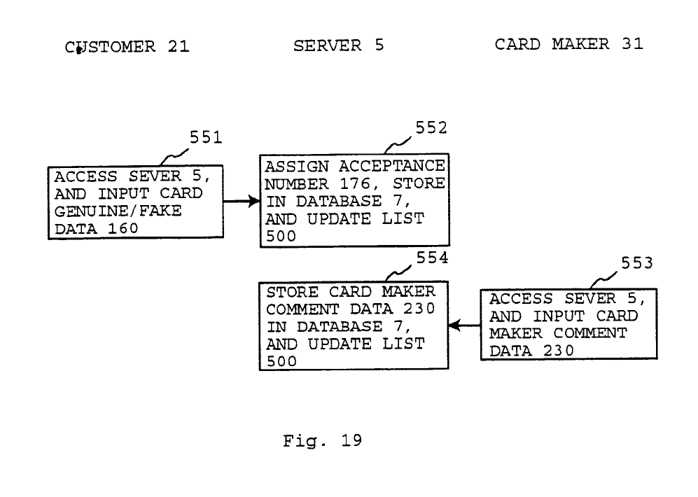

Next, operation of the card management system 1 for a damaged card will be described with reference to FIG. 18. FIG. 18 is a flowchart showing operation of the card management system 1 for a damaged card. As shown in FIG. 18, when a damaged card is contained in a card pack purchased by the customer 21, the customer 21 mails the damaged card to the card maker 31 (step 450) and accesses the server 5 from the terminal 23 in order to input the customer data 100 and the second card submission data 140 (step 451).

The server 5 adds to the second card submission data 140 the acceptance number data 158 indicating an acceptance number; stores them to the data base 7; and updates the list 500 (step 452). Specifically, the server 5 writes the contents of the second card submission data 140 into a corresponding column of the list 500; and opens the list 500 on the network. In step 452, the corresponding display items are displayed in the display columns 502, 504, 508, and 526.

The card maker 31 receives the damaged card sent from the customer 21 (step 453); and accesses the server 5 from the terminal 33 in order to input card acceptance data 210 (step 454). When the card maker 31 accesses the server 5 for the first time, the card maker may input the card maker data 200.

The server 5 receives the card acceptance data 210; store the data into the database 7; and updates the corresponding data of the list 500 (step 455). At this time, the corresponding display item is displayed in the display column 510 of the list 500.

Meanwhile, the card maker 31 repairs the damaged card and dispatches it to the customer 21 (step 456). However, in some cases, the card maker 31 exchanges the damaged card for a new one, or sends to the customer 21 a substitute card equivalent thereto. Moreover, the card maker 31 accesses the server 5 and inputs the card dispatch data 220 (step 457).

The server 5 receives the card dispatch data 220; stores the data into the database 7; and updates corresponding portions of the list 500 (step 458). At this time, data are displayed at the corresponding portion in the display column 512. Meanwhile, when the customer 21 receives the card dispatched from the card maker 31 (step 459), the customer 21 accesses the server 5 and inputs the correction status data 250 (step 460).

The server 5 receives the correction status data 250; stores the data into the database 7; and updates corresponding portions of the list 500 (step 461). At this time, data are displayed at the corresponding portions in the display columns 506, 514, and 528. Simultaneously, the counting of the elapsed days count displayed in the display column 516 is stopped, so that the number of days elapsed between the submission date and the reception date is displayed. When the card maker 31 does not dispatch any card to the customer 21, since the customer 21 naturally cannot receive any card, step 456 and subsequent steps are not performed. In such a case, items corresponding to the card dispatch data 220 and the correction status data 250 are not displayed on the list 500; and the counting of the elapsed days count displayed in the display column 516 is continued.

As described above, when the customer 21 requests the card maker 31 to handle the damaged card, the card management system 1 displays the details of the progress on the list 500, and discloses the list 500 on the network 11. Thus, the card management system 1 widely discloses the handling by the card maker 31 to thereby motivate the card maker 31 to provide responsible after-sales services.

Further, the ratio of dispatched cards to submitted damaged cards, the ratio of erroneous dispatches, the ratio of substitute articles, etc. can be calculated from the respective data and the list 500 stored in the database 7. The customer 21 can refer to the ratios when he or she purchases a new card.

When the card maker 31 provides faithful after-sales services, the card maker 31 can let many customers know about the faithful services, and can gain customer's trust. Thus, the card maker 31 can promote sales.

Next, operation of the card management system 1 for a card which is suspected to be fake will be described with reference to FIG. 19. FIG. 19 is a flowchart showing operation of the card management system 1 for a card suspected to be fake.

When a card suspected to be fake is contained in a card pack purchased by the customer 21, the customer 21 accesses the server 5 from the terminal 23, and inputs the card genuine/fake data 160 (step 551). The server 5 receives the card genuine/fake data 160; adds to the card genuine/fake data 160 the acceptance number data 176 indicating an acceptance number; stores them to the data base 7; and updates the list 500 (step 552). At this time, the corresponding display items are displayed in the display columns 502, 504, 530.

The card maker 31 accesses the server 5 from the terminal 33 and finds that information regarding the doubt that the card issued by the card maker 31 may be fake has been described in the list 500. In this case, the card maker 31 checks the image of the card and inputs an opinion on the checked image as the card-maker comment data 230 (step 553). When the card maker 31 accesses the server 5 for the first time, the card maker may input the card maker data 200.

The server 5 receives the card-maker comment data 230; store the data into the database 7; and updates the corresponding data of the list 500. At this time, the opinion is displayed at the corresponding portion in the display column 532 of the list 500.

As described above, when the card management system 1 is employed, information, including an image, of a card suspected to be fake is disclosed, and the customer 21 can know the opinion of the card maker 31. Therefore, the customer 21 can purchase cards without anxiety.

When the card maker 31 provides faithful after-sales services, the card maker 31 can let many customers know about the faithful services, and can gain customer's trust. Thus, the card maker 31 can promote sales.

Preferred embodiments of the card management system and the server of the present invention have been described with reference to the attached drawings. However, the present invention is not limited to the embodiments; as is apparent, persons with ordinary skill in the art can conceive various modifications of the embodiments within the technical idea described in the appended claims. Therefore, the present invention encompasses these modifications.

For example, the respective data may includes items other than those described in the embodiment. The input screens are not limited to the illustrated examples, and those having similar functions fall within the scope of the present invention.

As described above, when the present invention is practiced, a card maker's manner of handling cards such as redemption cards and damaged cards is disclosed; and consumers can refer to the disclosed information when purchasing new cards. When the card maker handles those cards unfaithfully, the unfaithful treatment becomes widely known among many consumers, and may hinder sales activity. Therefore, quick and proper handling by the card maker can be encouraged; and consumers can purchase cards without anxiety. Moreover, if the card maker always provide faithful handling, the card maker can gain consumers' trust, so that the card maker and their agencies can promote their sales.

What is claimed is:

1. A card management system comprising a server; and first and second terminals connected to the server via a network, wherein
the first terminal comprises means for transmitting to the server first data including information for specifying a card and information representing a condition of the card;
the server comprises means for storing the first data; and means for disclosing the first data on the network;
the second terminal comprises means for transmitting to the server second data including information representing the manner in which a maker of the card has handled the card;
the first terminal further comprises means for transmitting to the server third data including information representing a manner in which the maker of the card has handled the card; and
the server further comprises means for storing the second and third data; and means for disclosing the second and third data on the network.

2. A card management system according to claim 1, wherein the server further comprises:
means for assigning a unique number or symbol to the first data;
means for storing the assigned number or symbol together with the first data; and
means for disclosing on the network the assigned number or symbol together with the first data.

3. A card management system according to claim 1, wherein the card-is a redemption card.

4. A card management system according to claim 1, wherein the card is a damaged card.

5. A card management system comprising a server; and first and second terminals connected to the server via a network, wherein
the first terminal comprises means for transmitting to the server first data including information for specifying a card which is suspected to be fake and image information of the card;
the second terminal comprises means for transmitting to the server second data including an opinion on the card of the maker of the card; and
the server comprises means for storing the first and second data; and means for disclosing the first and second data on the network.

6. A card management system according to claim 5, wherein the server further comprises:
means for assigning a unique number or symbol to the first data;
means for storing the assigned number or symbol together with the first data; and
means for disclosing on the network the assigned number or symbol together with the first data.

7. A server connected to first and second terminals via a network, comprising:
means for storing first data transmitted from the first terminal and including information for specifying a card and information representing a condition of the card, second data transmitted from the second terminal and including information representing a manner in which a maker of the card has handled the card, and third data transmitted from the first terminal and including information representing a manner in which the maker of the card has handled the card; and
means for disclosing the first, second, and third data on the network.

8. A server according to claim 7, further comprising:
means for assigning a unique number or symbol to the first data;
means for storing the assigned number or symbol together with the first data; and
means for disclosing on the network the assigned number or symbol together with the first data.

9. A server according to claim 7, wherein the card is a redemption card.

10. A server according to claim 7, wherein the card is a damaged card.

11. A server connected to first and second terminals via a network, comprising:
means for storing first data transmitted from the first terminal and including information for specifying a card which is suspected to be fake and an image information of the card, and second data transmitted from the second terminal and including an opinion on the card of the maker of the card; and
means for disclosing the first and second data on the network.

12. A server according to claim 11, further comprising:
means for assigning a unique number or symbol to the first data;
means for storing the assigned number or symbol together with the first data; and
means for disclosing on the network the assigned number or symbol together with the first data.
